(19) United States
(12) Patent Application Publication
(10) Pub. No.: US 2026/0187529 A1
(43) Pub. Date: Jul. 2, 2026

(54) USING AN ACTION GRAPH TO AUTOMATE TASKS

(71) Applicant: GOOGLE LLC, Mountain View, CA (US)

(72) Inventors: Dongeek Shin, San Jose, CA (US); Diego Rivas Vetencourt, San Francisco, CA (US)

(21) Appl. No.: 19/179,779

(22) Filed: Apr. 15, 2025

Related U.S. Application Data
(60) Provisional application No. 63/740,945, filed on Dec. 31, 2024.

(51) Int. Cl. G06N 20/00; G06F 17/40

(52) U.S. Cl. CPC G06N 20/00; G06F 17/40

(57) ABSTRACT

A method comprises receiving a natural language input related to a task; providing the natural language input to a generative model, the generative model identifying an action traversal for performing the task based on the natural language input, the action traversal representing a path through an action graph, the action graph including a plurality of nodes representing actions relevant to the task, the nodes connected by edges representing probabilities of child nodes following parent nodes; receiving the action traversal; and in response to receiving the action traversal, performing a first action in the action traversal.

### CROSS-REFERENCE TO RELATED APPLICATION

This Application claims the benefit of priority to U.S. Provisional Application No. 63/740,945, filed on Dec. 31, 2024, the disclosure of which is hereby incorporated by reference.

### BACKGROUND

Natural language input can make using computing features easier for users. However, determining the appropriate actions based on the language input can be difficult. A limited set of possible actions can reduce the ability of a computing system to respond to many language inputs, whereas a wide set of possible actions can be computationally expensive and provide less accurate actions.

### SUMMARY

Implementations enable users to provide natural language input to an agent configured to perform tasks on behalf of the user, via either typewritten text or transcribed audio input. Example agents can perform a task requested by the user using a natural language input based an action graph. The action graph can include nodes representing the actions that can accomplish a task. The task can include actions that perform a function, e.g., by launching an application or calling an application programming interface (API). The actions can also include providing input without interaction with the user. The actions can include selections of further function calls or atomic input events such as text input, mouse clicks, or scrolls. The nodes included in the action graph correspond to fewer than all possible actions. The nodes included in the action graph can correspond to actions that the user is likely to perform and/or select as part of a task. The agent can be based on a generative model, such as a vision language model or language model. The agent may be used in generating the action graph from historical actions obtained with user consent. The nodes of the action graph are connected by edges that represent probabilities of the target action (e.g., second action) following the source action (first action). To perform the task requested by the user the agent may generate an action traversal of the action graph, the action traversal representing a path through the action graph that is likely to accomplish the task. The generation of the graph with nodes corresponding to fewer than all possible actions to accomplish a task enables flexible and accurate performance of tasks requested using natural language input while working within constraints of computing system resources.

According to an example, a method comprises receiving a natural language input related to a task; providing the natural language input to a generative model, the generative model identifying an action traversal for performing the task based on the natural language input, the action traversal representing a path through an action graph, the action graph including a plurality of nodes representing actions relevant to the task, the nodes connected by edges representing probabilities of child nodes following parent nodes; receiving the action traversal; and in response to receiving the action traversal, performing a first action in the action traversal.

According to an example, a non-transitory computer-readable storage medium comprises instructions stored thereon. When executed by at least one processor, the instructions are configured to cause a computing system to receive a natural language input related to a task; provide the natural language input to a generative model, the generative model identifying an action traversal for performing the task based on the natural language input, the action traversal representing a path through an action graph, the action graph including a plurality of nodes representing actions relevant to the task, the nodes connected by edges representing probabilities of child nodes following parent nodes; receive the action traversal; and in response to receiving the action traversal, perform a first action in the action traversal.

According to an example, a computing system comprises at least one processor and a non-transitory computer-readable storage medium comprising instructions stored thereon. When executed by the at least one processor, the instructions are configured to cause the computing system to receive a natural language input related to a task; provide the natural language input to a generative model, the generative model identifying an action traversal for performing the task based on the natural language input, the action traversal representing a path through an action graph, the action graph including a plurality of nodes representing actions relevant to the task, the nodes connected by edges representing probabilities of child nodes following parent nodes; receive the action traversal; and in response to receiving the action traversal, perform a first action in the action traversal.

The details of one or more implementations are set forth in the accompanying drawings and the description below. Other features will be apparent from the description and drawings, and from the claims.

### BRIEF DESCRIPTION OF THE DRAWINGS

FIG. 1 shows an action graph and natural language input.

FIG. 2A shows an example of a graph, according to an implementation.

FIG. 2B shows another example of a graph, according to an implementation.

FIG. 3 shows an example action traversal using an action graph based on natural language input, according to an implementation.

FIGS. 4A-4D show example user interfaces that may result from actions performed as part of the action traversal of FIG. 3, according to disclosed implementations.

FIG. 5 shows an example action traversal using an action graph based on natural language input.

FIGS. 6A-6D show example user interfaces that may result from actions performed as part of the action traversal of FIG. 5, according to disclosed implementations.

FIG. 7 shows an example action traversal using an action graph based on natural language input.

FIGS. 8A-8C show example user interfaces that may result from actions performed as part of the action traversal of FIG. 7, according to disclosed implementations.

FIG. 9 shows an example action traversal using an action graph based on natural language input.

FIGS. 10A and 10B show example user interfaces that may result from actions performed as part of the action traversal of FIG. 9, according to disclosed implementations.

FIG. 11 is a block diagram of a computing system.

FIG. 12 is a flowchart of a method performed by a computing system.

Like reference numbers refer to like elements.

### DETAILED DESCRIPTION

Users may provide natural language input, via typed text or transcribed audio input, to an agent using artificial intelligence, e.g., an AI agent. The AI agent can perform a task based on the natural language input, such as launching an application. Some agents operate on a predetermined, limited set of actions. A technical problem with predetermining a limited set of actions for performing a task is that the limited set of actions is not scalable to complex tasks and lacks flexibility to perform actions not included in the predetermined, limited set. The lack of scalability limits the usefulness of the agent. Other agents perform tasks frame-by-frame. Such an agent performs a task one “frame” at a time, taking screenshots of the user interfaces that result from an action and determining what action to perform next based on what the user interfaces look like. While such agents scale to complex actions, they have low reliability and are slow, due to multiple calls to the generative model to determine the next action at each step, which consumes large amounts of computing resources.

A technical solution to these technical problems includes generating an action graph in response to receiving natural language input requesting a task. The graph can include nodes associated with tasks performed in a general space, such as file system management. The nodes correspond to actions performed within the general space and can accommodate complex tasks with high accuracy and low latency. The nodes can correspond to fewer than all possible actions that could be performed within the general space. In some implementations, the graph includes nodes corresponding to actions that satisfy a likeliness or frequency threshold. Generating the action graph can include removing or pruning edges between nodes based on the natural language input. The threshold represents a probability that the action would be performed after a preceding action was performed or after a given input. The agent can traverse the action graph and perform actions to accomplish the task. The agent can call itself to accomplish sub-tasks, e.g., to complete a given action the agent may traverse the action graph (or a second action graph) to determine what actions to perform to accomplish the sub-task. At least some technical benefits of this technical solution of generating and using the action graph include flexibility to perform actions likely to be desired by the user, scalability to complex actions, reliability and accuracy in determining the action desired by the user, and/or low latency in responding to the natural language input and performing the desired action.

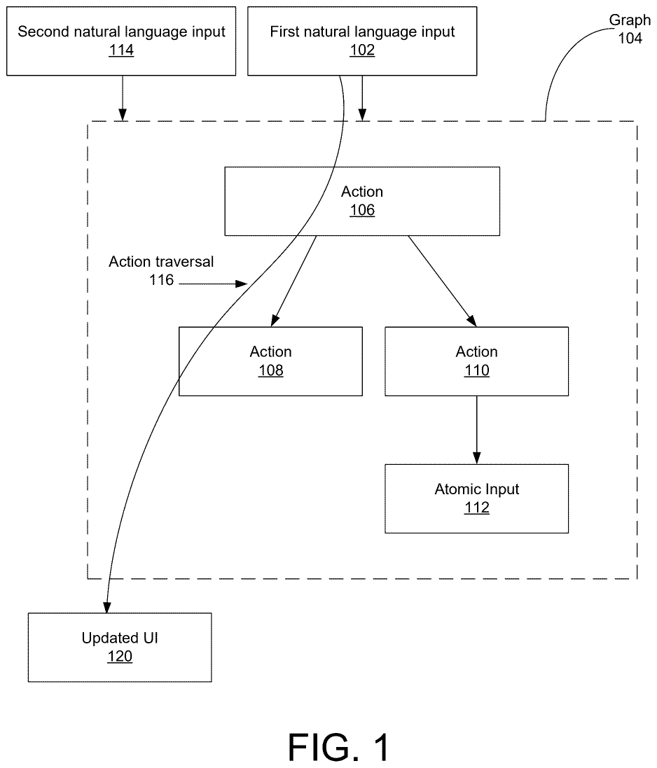

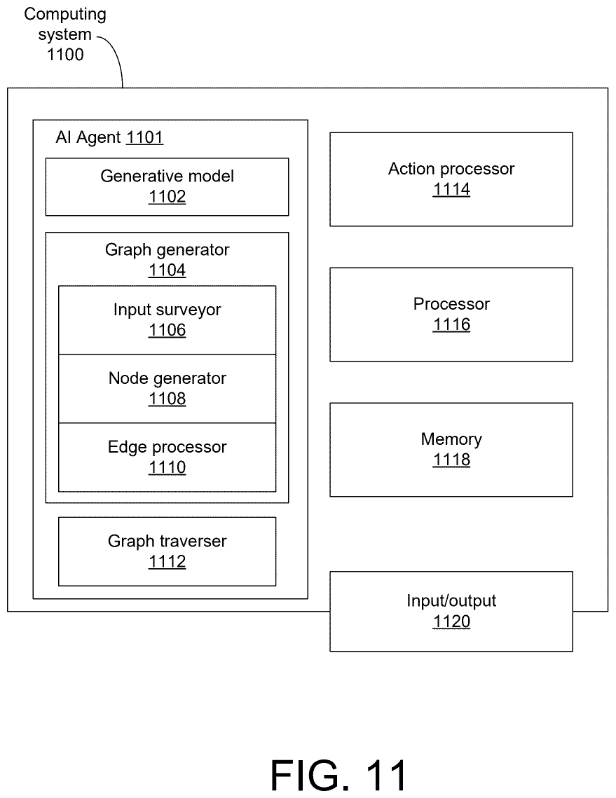

FIG. 1 shows an action graph 104 and natural language input 102, 114. A computing system, i.e., an AI agent executing on the computing system, generates the graph 104 based on a first natural language input 102. An example of the computing system is shown and described with respect to FIG. 11. In some implementations, the natural language input 102, 114 includes text entered into the computing system via keyboard, touchscreen, or microphone.

The computing system can interpret the first natural language input 102 to determine, among multiple potential actions to perform, to perform the action 106 and the action 108 to complete a task represented by first natural language input 102. The AI agent (specifically, a generative model used by the AI agent) can interpret the natural language input 102 by implementing natural language understanding to understand the meaning (semantics) expressed in a language used by humans, such as English, French, or Mandarin, without the formalized syntax of a computer language. The natural language understanding can include intent recognition to identify a user's sentiment in input text (such as the first natural language input 102) and use of the intent recognition to determine an objective of the input text, i.e., a task. Natural language understanding also includes entity recognition, e.g., identifying an entity in the input text and extracting information about the entity. In some implementations, the first natural language input 102 and a second natural language input 114 can be parsed from a single sequence of text (such as entered into a text field as a singular text entry). In some implementations, the first natural language input 102 and second natural language input can be separate sequences of text, such as entered into text fields separately or transcribed from sentences spoken at times separated by at least a threshold time difference.

The action 106 can include launching an application, calling an application programming interface (API), or atomic input events received via a human interface device such as clicking on buttons or hyperlinks, scrolling on a scrollbar, or entering text into a field, as non-limiting examples. The action 106 can be associated with multiple actions. For example, an action can include obtaining another action traversal representing a sub-task of the task. Actions can include coarse calls to other functions, such as API calls, or atomic input events such as clicking on buttons or hyperlinks, scrolling on a scrollbar, or entering text into a field, as non-limiting examples.

In some implementations, the action 106 can be based on the first natural language input 102. For example, the action 106 could be a search query, with the search terms including a portion of the natural language input 102. In some examples, the action 106 could be opening a file on a computing system. If the file is named in the first natural language input 102, the subsequent action could be the action 108. If the file is not named in the first natural language input 102, the next action could be action 110, requesting a name of the file, and the action after the action 110 could be receiving atomic input 112, such as keyboard input indicating the name of the file.

The computing system can generate the action traversal 116 based on the first natural language input 102 and may base the action traversal 116 on the second natural language input 114. In some cases, an additional action traversal for a sub-task may be based on the second natural language input 114. In some implementations, the computing system generates the action graph 104 based on, with user consent, interaction histories of multiple users performing tasks. In some implementations, the computing system generates nodes in the graph 104 based on an interaction history of a current user. In some implementations, and with user consent, the computing system generates the graph 104 based on the graph 104 and an interaction history of a current user and other users within the action 106.

The nodes within the graph 104 correspond to actions that can be included in an action traversal to perform a task by the AI agent. In the example shown in FIG. 1, the nodes of the graph 104 include the action 106, an action 108, an action 110, and atomic input 112, which are illustrated for ease of discussion. However, the graph 104 can include more nodes than shown in the example of FIG. 1.

In some implementations, the actions 106, 108, 110 include multiple subtasks or actions to achieve a goal or task. For example, opening a file for which the name is included in the first natural language input 102 could include determining a folder that includes the file, navigating to and opening the folder that includes the file, and selecting and opening the file within the folder. Saving a file could include selecting a folder to save the file in, entering a save instruction, and entering the name of the file to be saved.

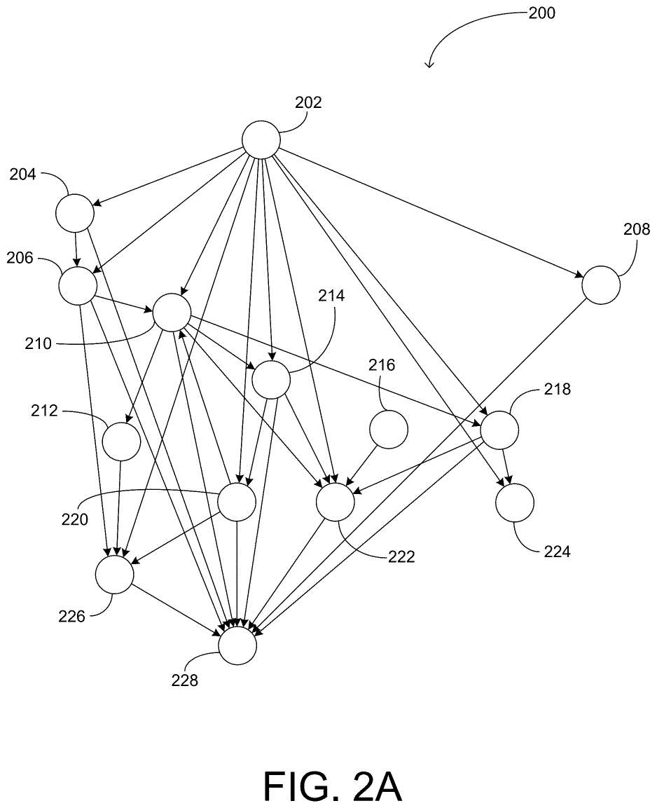

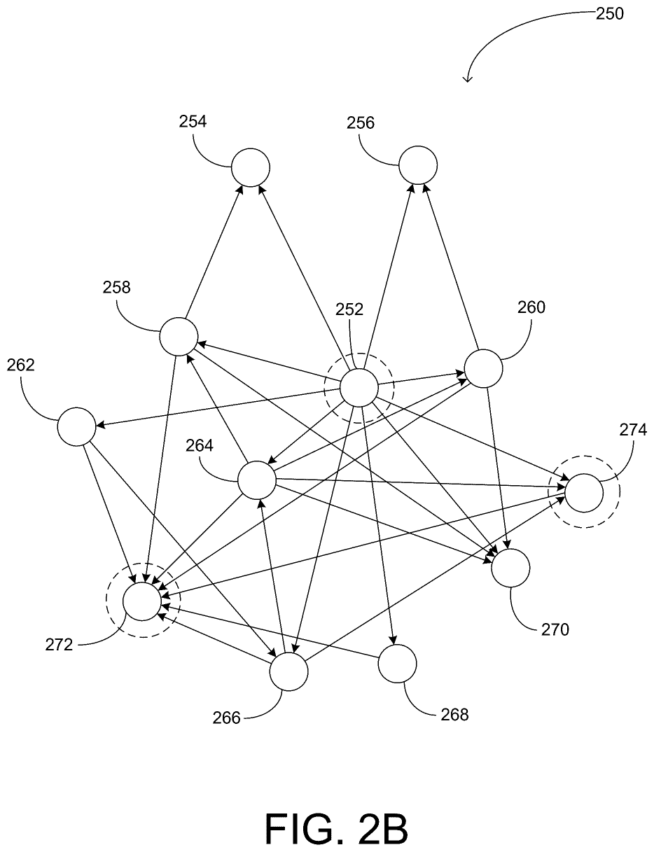

The AI agent can generate the graph 104 based on the first natural language input 102. The agent can interpret the first natural language input 102 to determine a task or goal of the natural language input 102. The AI agent can generate the graph 104 based on determining a task based on the first natural language input and actions needed to perform steps of the task. In some implementations, the AI agent generates the graph 104 by pruning edges from an action repository, such as the graphs 200, 250 shown and described with respect to FIGS. 2A and 2B, based on the first natural language input 102. The AI agent can generate the graph 104 by pruning edges from the action repository that do not connect to nodes representing actions related to the task or goal of the first natural language input 102. In some implementations, the AI agent generates the graph 104 by pruning edges of the action repository based on the task or goal of the natural language input 102 and likelihood of actions represented by the nodes being performed.

In some implementations, the computing system includes nodes in the graph 104 based on a combination of the task or goal of the first natural language input 102 and likelihoods of the nodes being performed or selected by a user if the user were to perform the task. The likelihood can be based on performance of the action by a user corresponding to the node when performing a task. The likelihoods can be based on previous interactions by the current user and/or other users who have performed the task. The likelihoods can be expressed as frequencies of previous selections of actions corresponding to the nodes. The frequencies of previous selections can be frequencies of selection after another node. For example, the more often users perform the action associated with one node (a child node, target node, or second node) after performing the action associated with another node (a parent node, source node, or first node), the higher the value of the likelihood or frequency represented by the edge from the source node to the target node would be. The computing system includes a given node in the graph 104 if a frequency of selection of the action corresponding to the node satisfies a frequency threshold. In some implementations, the computing system and/or AI agent includes a given node if the action corresponding to the node is relevant to the goal of the first natural language input 102 and the frequency of selection of the action corresponding to the node satisfies the frequency threshold. Satisfying a frequency threshold includes meeting or exceeding the frequency threshold where higher frequency is desired. The computing system can determine not to include, determine to exclude, and/or determine to remove, a given node from the graph 104 if a frequency of selection of the action corresponding to the node does not satisfy the frequency threshold and/or if the action corresponding to the node is not relevant to, or would not help to achieve, the goal of the first natural language input. In some implementations, a node can represent a sequence of actions that are likely to be taken together, such as the user launching a web browser, entering a particular universal resource locator (URL) into an address field, and navigating a cursor to a login or authentication field.

The AI agent can determine actions within the action traversal 116 based on the first natural language input 102. The AI agent can determine actions within the action traversal 116 that are most likely to achieve the goal, or task, of the first natural language input 102.

In the example shown in FIG. 1, the computing system generates the action traversal 116 that includes the action 106, and the action 108. Action 110 is also a possible action in the action graph that follows performing the action 106, but is not selected for the action traversal 116 based on the first natural language input 102 and/or the second natural language input 114. If the first natural language input 102 had caused the computing system to perform the action 110, then the computing system can receive atomic input 112 after performing the action 110 or as part of the action 110. The atomic input 112 can include input from a human interface device such as a computer mouse, a keyboard, and/or a touchscreen. For example, atomic input can include character input or selection from a keyboard, directional input from a computer mouse, clicking or holding one or more buttons on a computer mouse, or a combination of directional and button input on a computer mouse such as scrolling an image by dragging a scrollbar presented by the computing system as part of performing the action 110, or touchscreen input, as non-limiting examples. If the first natural language input 102 causes the computing system to perform the action 108, the action 108 can include receiving and/or processing second natural language input 114. In some implementations, the computing system performs the action 108 based on the AI agent determining that a correlation between the second natural language input 114 and the action 108 is higher than a correlation between the second natural language input 114 and the action 110. In an example in which the first action 108 includes retrieving a file, the first natural language input 102 can indicate the action of retrieving a file via the action 106 and the second natural language input 114 can indicate and/or identify the file, with the indication or identification processed as part of the first action 108. In the example shown in FIG. 1, the computing system performs an action traversal 116, responding to the first natural language input 102 by performing the action 106 and the action 108, with the first action 108 receiving and/or processing second natural language input 114. After performing the action traversal 116 including the action 106 and the action 108, the computing system can present an updated user interface (UI) 120 to the user. The updated UI 120 can include changes to the UI based on the actions performed during the traversal 116.

FIG. 2A shows an example of graph 200. The graph 200 can have similar features as the graph 104 described with respect to FIG. 1. The graph 200 is not a fully connected graph because not all nodes in the graph 200 are connected to each other by edges. The lack of full connection within the graph 200 can be based on the inability to perform some actions represented by nodes after some other actions represented by nodes. The graph 200 can be considered an action repository that includes nodes and edges representing actions that can be taken by a computing device. The nodes in the action repository (graph 200) represent the actions a user device can perform, including atomic input actions that require user interaction. The edges between nodes represent an order in which the actions can occur. Inward-bound edges can point to child nodes (or target nodes) that represent actions that can be performed after performing actions represented by nodes from which the inward-bound edge points. The node from which the inward-bound edge points, and from which the edge can be considered outward-bound, can be considered a parent node (or source node) with respect to the node to which the edge points. For example, the computing system can summarize content, represented by node 212, only after copying the content, represented by node 210. The edges can be weighted, with the weight representing a probability that the child (target) node follows the parent (source) node. The probability of the child (target) node following the parent (source) node can correspond to a probability of traversing an edge from the child (target) node to the parent (source node). The probability of traversing the edge can be based on a user intent and/or a reliability score. The user intent can correspond to the task that the user desires to achieve. The AI agent can determine the user intent and/or task based on the natural language input. The AI agent can precompute the reliability score to determine a likelihood and/or probability of achieving the user intent and/or task by traversing the edge. As with words in a language model, these weights can depend on the combination of actions already performed, i.e., the order of the ancestor nodes.

After receiving a natural language input, the AI agent can generate an action graph based on the natural language input. The AI agent can generate the action graph based on the action repository (such as the graph 200) and the natural language input. The graph 104 is an example of an action graph that can be generated based on an action repository and the natural language input. For example, the AI agent may provide the natural language input to a generative model configured to use the action repository to determine the action graph. In a manner similar to a generative language model that determines which words in which order are relevant to a prompt from a user, the generative model used by the AI agent may determine which actions from the action repository are relevant to the natural language input and the possible flows through the action that might be possible to accomplish the task. For example, generative model may exclude and/or prune edges and nodes from the action graph due to the likelihood or frequency of performing some actions relating to the task not satisfying a frequency threshold. The likelihoods and/or frequencies of actions being performed after previous actions can be based on, with user permission, previous actions by the user and/or other users performing similar actions. In some implementations, the AI agent can determine the likelihoods and/or frequencies of actions being performed after previous actions based on the natural language input. In some implementations, the AI agent can determine the likelihoods and/or frequencies of actions being performed after previous actions based on a combination of the natural language input and previous actions by the user and/or other users performing similar actions who have expressly agreed to storage of actions for training purposes.

In the example shown in FIG. 2A, a first node 202 corresponds to an action for processing input, such as a natural language command or request entered by the user. Node 202 is connected to node 204, which corresponds to an action of opening a web browser. Node 202 is also connected to node 206, which corresponds to an action of entering a search query in a web browser. Node 202 is also connected to node 208, which corresponds to an action of pulling a setup user interface, such as an arrangement of applications that the user has set up for a work environment or an arrangement of applications that the user has set up for an entertainment environment. Node 202 is also connected to node 210, which corresponds to an action of copying content (such as text content in a window). Node 202 is also connected to node 214, which corresponds to an action of opening a file. Node 202 is also connected to node 218, which corresponds to an action of opening a folder or a file. Node 202 is also connected to node 220, which corresponds to an action of performing a search. Node 202 is also connected to node 222, which corresponds to an action of pasting content (such as adding copied text to a text editor or adding a copied file to a directory or folder). Node 202 is also connected to node 224, which corresponds to an action of organizing content (such as moving files within directories of folders). Finally, in the example of FIG. 2A, node 202 is also connected to node 226, which corresponds to an action of entering a manual mode of receiving input via a human interface device. For example, the user may enter commands via a command line interface by typing into a keyboard, may provide touch input into a touchscreen, may provide voice input via a microphone, or may provide directional and button input via a computer mouse by mouse movements and clicks. Node 204 is connected to node 206 and to node 228, which corresponds to an action of exiting a function or application. Node 206 is connected to node 210, node 228, and node 226. Node 208 is connected to node 228. Node 210 is connected to node 212, which corresponds to an action of summarizing content currently in memory, node 214, node 218, and node 226. Node 212 is connected to node 226 and node 228. Node 214 is connected to node 220, node 222, and node 228. Node 216, which corresponds to an action of creating a folder or directory, is connected to node 222. Node 218 is connected to node 224 and node 228. Node 220 is connected to node 228. Node 222 is connected to node 228. Node 224 is not connected to any subsequent nodes. Node 226 is connected to node 228. Node 228 is not connected to any subsequent nodes because node 228 corresponds to an exit action that represents the end of the actions performed by the AI agent for a particular task. The node 228 may be the last node in any action traversal or the last node of an action traversal for a sub-task.

The AI agent can determine which nodes within the graph 200 to traverse, and corresponding actions to perform, based on natural language input received by the agent. The AI agent can determine which nodes within the graph 200 to traverse after some of the edges within the graph 200 have been pruned, to generate an action graph, based on the natural language input and/or frequencies of actions being performed. The AI agent can determine a most likely node to traverse to from a given node based on nodes to which the given node has edges and the natural language input. The AI agent can determine the subsequent node to the given node by determining which node, among nodes to which the given node has edges, corresponds to an action that has the highest probability of continuing a task determined based on the natural language input. The AI agent can determine which path of nodes and corresponding actions are most correlated with the task determined based on the natural language input by determining subsequent actions that are most likely based on a current action that corresponds to the given node.

FIG. 2B shows a graph 250 and edges generated based on natural language input. The graph 250 can have similar features as the graph 104 described with respect to FIG. 1 and/or the graph 200 described with respect to FIG. 2A. The graph 250 is not a fully connected graph because not all nodes in the graph 250 are connected to each other by edges. The lack of full connection within the graph 250 can be based on the inability to perform some actions represented by nodes after some other actions represented by nodes. The graph 250 can be considered an action repository that includes nodes and edges representing actions that can be taken after other actions have occurred. Inward-bound edges can point to child nodes that represent actions that can be performed after actions represented by nodes from which the inward-bound edge points. The node from which the inward-bound edge points, and from which the edge can be considered outward-bound, can be considered a parent node with respect to the node to which the edge points. The AI agent can generate an action graph by excluding and/or pruning edges from the action repository due to the likelihood or frequency of performing some actions not satisfying a frequency threshold. The likelihoods and/or frequencies of actions being performed after previous actions can be based on previous actions by the user and/or other users performing similar actions who have expressly agreed to storage of actions for training purposes. In some implementations, the AI agent can determine the likelihoods and/or frequencies of actions being performed after previous actions based on the natural language input. In some implementations, the AI agent can determine the likelihoods and/or frequencies of actions being performed after previous actions based on a combination of the natural language input and previous actions by the user and/or other users performing similar actions who have expressly agreed to storage of actions for training purposes.

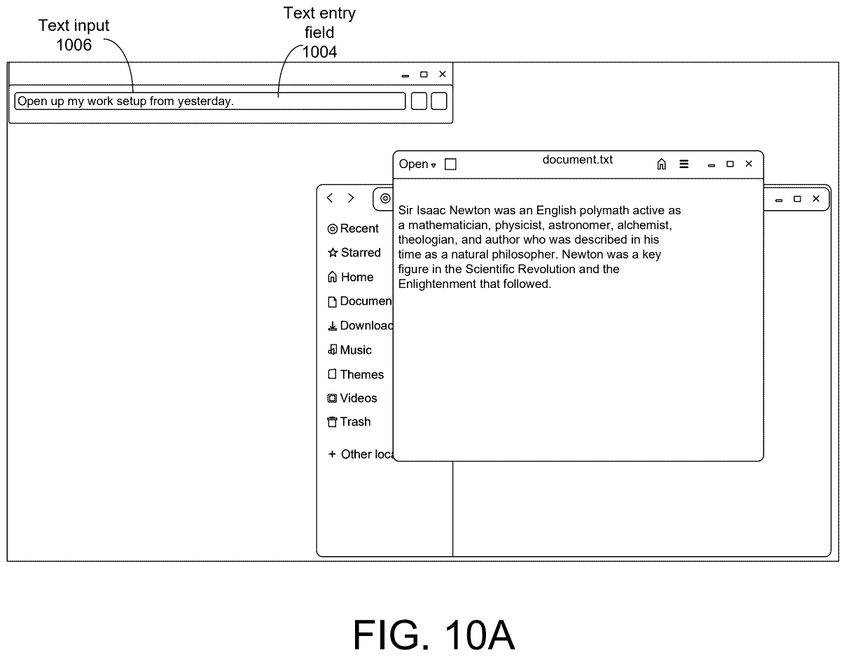

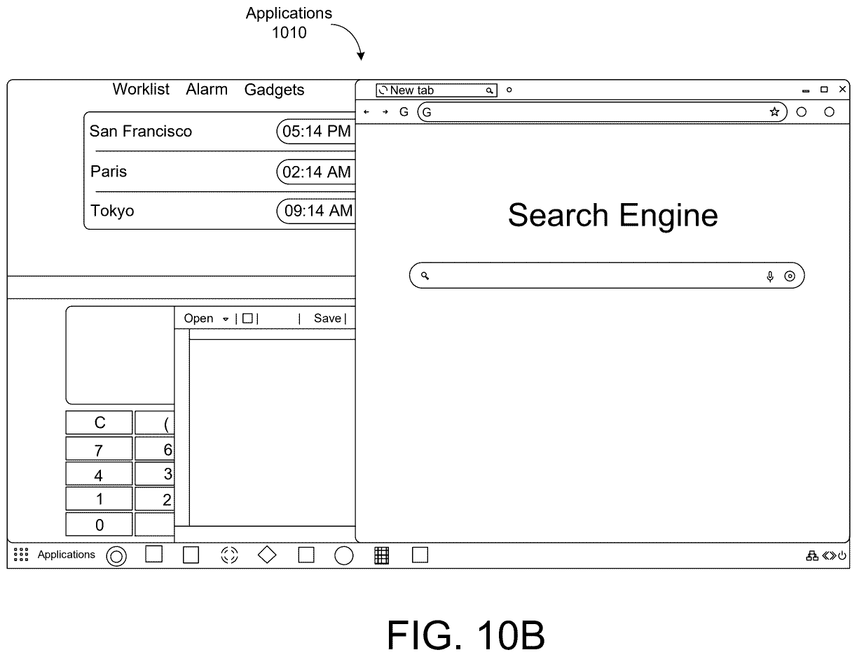

In the example shown in FIG. 2B, a first node 252 corresponds to an action for processing input, such as a natural language command or request entered by the user. Node 252 is connected to node 254 by an outbound edge, and node 254 is connected to node 252 by an inbound edge. Node 254 corresponds to an action of searching. Searching can include searching a local directory of files or a remote directory, such as searching the Internet. Node 252 can be considered a parent node with respect to node 254, and node 254 can be considered a child node with respect to node 252. Node 252 is also connected to node 256 by an outbound edge, and node 256 is connected to node 252 by an inbound edge. Node 256 corresponds to an action of organizing content. Organizing content can include moving files into and/or between folders or directories. Node 252 can be considered a parent node with respect to node 256, and node 256 can be considered a child node with respect to node 252. Node 252 is connected to node 258 by an outbound edge, and node 258 is connected to node 252 by an inbound edge. Node 258 represents an action of opening an application. The application can be a local application that the local computer is capable of opening, launching, and/or executing. Node 252 can be considered a parent node with respect to node 258, and node 258 can be considered a child node with respect to node 252. Node 252 is also connected to node 260 by an outbound edge, and node 260 is connected to node 252 by an inbound edge. Node 260 represents an action of opening a folder, which can result in presenting files stored in the opened folder. Node 252 can be considered a parent node with respect to node 260, and node 260 can be considered a child node with respect to node 252. Node 252 is also connected to node 262 by an outbound edge, and node 262 is connected to node 252 by an inbound edge. Node 262 represents an action of opening a web browser. Opening the web browser can include opening, launching, and/or executing a web browser that requests content such as webpages from remote servers, renders and displays webpages to the users, and receives input via the webpages from the user and/or AI agent. Node 252 is connected to node 264 by an outbound edge, and node 264 is connected to node 252 by an inbound edge. Node 264 represents an action of copying content. The content can be copied from a local document (such as a text or word processing document) or a webpage, as non-limiting examples. Node 252 can be considered a parent node with respect to node 264 and node 264 can be considered a child node with respect to node 252. Node 252 is connected to node 266 by an outbound edge, and node 266 is connected to node 252 by an inbound edge. Node 266 represents an action of searching the World Wide Web and/or searching the Internet. Searching the World Wide Web and/or Internet can include entering search terms into a search engine and receiving search results from the search engine. Node 252 can be considered a parent node with respect to node 266, and node 266 can be considered a child node with respect to node 252. Node 252 can be connected to node 268 by an outbound edge, and node 268 can be connected to node 252 by an inbound edge. Node 268 can represent an action of pulling a setup. Pulling a setup can include opening applications associated with a particular setup, such as a work setup or a leisure setup. FIG. 10B shows an example of opening a work setup. Node 252 can be considered a parent node with respect to node 268, and node 268 can be considered a child node with respect to node 252. Node 252 is connected to node 270 by an outbound edge, and node 270 can be connected to node 252 by an inbound edge. Node 270 can represent an action of pasting content. Pasting content can include inserting content into a document. The content may have previously been copied and/or stored. Node 252 can be considered a parent node with respect to node 270, and node 270 can be considered a child node with respect to node 252. Node 252 is connected to node 274 by an outbound edge, and node 274 is connected to node 252 by an inbound edge. Node 274 represents receiving and/or processing manual input. Manual input can include atomic input that can be received via a human interface device, such as key selections received via a keyboard (either a physical keyboard, a soft keyboard implemented by a touch screen, or a virtual keyboard implemented by a virtual reality or augmented reality environment), clicking input received via a computer mouse or touchscreen, or scrolling or directional input received via a computer mouse, as non-limiting examples. Node 252 can be considered a parent node with respect to node 274, and node 274 can be considered a child node with respect to node 252.

In the example shown in FIG. 2B, node 258 is connected to node 254 by an outbound edge, and node 254 is connected to node 258 by an inbound edge. Node 258 can be considered a parent node with respect to node 254, and node 254 can be considered a child node with respect to node 258. Node 258 is connected to node 270 by an outbound edge, and node 270 is connected to node 258 by an inbound edge. Node 258 can be considered a parent node with respect to node 270, and node 270 can be considered a child node with respect to node 258. Node 258 is connected to node 272 by an outbound edge, and node 272 is connected to node 258 by an inbound edge. Node 272 can represent an exit action, exiting the graph 250 and/or performing no further action until entering a new graph and/or receiving input from the user. Node 272 can be considered a grandchild node of node 252 via node 258, and node 252 can be considered a grandparent node of node 272 via node 258.

In the example shown in FIG. 2B, node 260 is connected to node 256 via by an outbound edge, and node 256 is connected to node 260 by an inbound edge. Node 260 can be considered a parent node with respect to node 256, and node 256 can be considered a child node with respect to node 260. Node 260 is connected to node 270 by an outbound edge, and node 270 is connected to node 260 by an inbound edge. Node 260 can be considered a parent node with respect to node 270, and node 270 can be considered a child node with respect to node 260.

In the example shown in FIG. 2B, node 262 is connected to node 272 via by an outbound edge, and node 272 is connected to node 262 by an inbound edge. Node 262 can be considered a parent node with respect to node 272, and node 272 can be considered a child node with respect to node 262. Node 262 is connected to node 266 by an outbound edge, and node 266 is connected to node 262 by an inbound edge. Node 262 can be considered a parent node with respect to node 266, and node 266 can be considered a child node with respect to node 262.

In the example shown in FIG. 2B, node 264 is connected to node 258 by an outbound edge, and node 258 is connected to node 264 by an inbound edge. Node 264 can be considered a parent node with respect to node 258, and node 258 can be considered a child node with respect to node 264. Node 264 is connected to node 272 by an outbound edge, and node 272 is connected to node 264 by an inbound edge. Node 264 can be considered a parent node with respect to node 272, and node 272 can be considered a child node with respect to node 264. Node 252 can be considered a grandparent node with respect to node 272 via node 264, and node 272 can be considered a grandchild node with respect to node 252 via node 264. Node 264 is connected to node 270 by an outbound edge, and node 270 is connected to node 264 by an inbound edge. Node 264 can be considered a parent node with respect to node 270, and node 270 can be considered a child node with respect to node 264.

In the examples sown in FIG. 2B, node 266 is connected to node 264 by an outbound edge, and node 264 is connected to node 266 by an inbound edge. Node 266 can be considered a parent node with respect to node 264, and node 264 can be considered a child node with respect to node 266. Node 266 is connected to node 272 by an outbound edge, and node 272 is connected to node 266 by an inbound edge. Node 266 can be considered a parent node with respect to node 272, and node 272 can be considered a child node with respect to node 266. Node 252 can be considered a grandparent node with respect to node 272 via node 266, and node 272 can be considered a grandchild node with respect to node 252 via node 266. Node 266 is connected to node 274 by an outbound edge, and node 274 is connected to node 266 by an inbound edge. Node 266 can be considered a parent node with respect to node 274, and node 274 can be considered a child node with respect to node 266.

In the example shown in FIG. 2B, node 268 is connected to node 272 by an outbound edge, and node 272 is connected to node 268 by an inbound edge. Node 268 can be considered a parent node with respect to node 272, and node 272 can be considered a child node with respect to node 268. Node 252 can be considered a grandparent node with respect to node 272 via node 268, and node 272 can be considered a grandchild node with respect to node 252 via node 268.

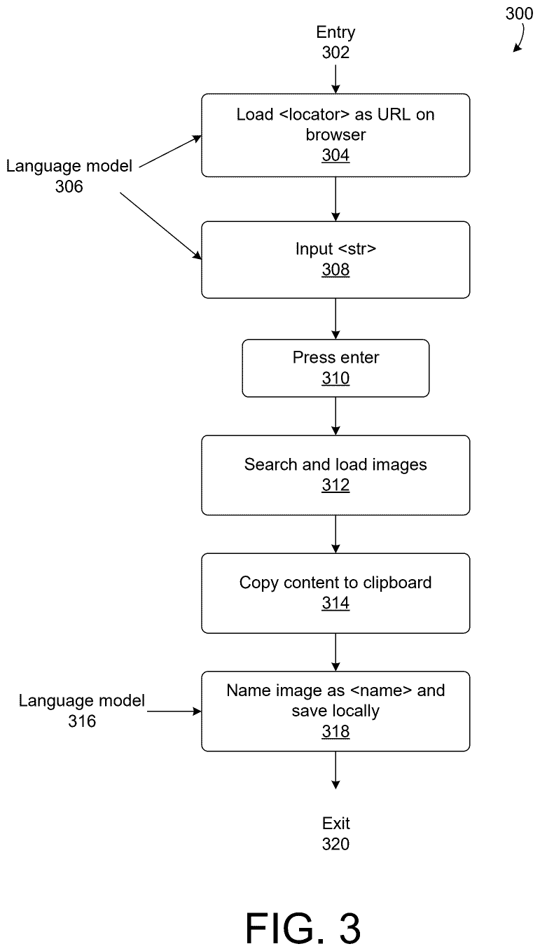

FIG. 3 shows an example action traversal 300 using an action graph, such as graph 200, based on natural language input. In this example, the natural language input can include text, “Download an image of a pink elephant here. Name it pinkpink.png”, which represents a requested task. In some implementations, the action traversal 300 may be presented to a user before it is processed (executed) by the AI agent. In such implementations, the user may be given an opportunity to edit the action traversal 300 before it is processed. Editing the action traversal 300 can include changing nodes, and/or a sequence of nodes, traversed during the action traversal 300. In some implementations, editing the action traversal 300 may cause the computing system to update the action graph. Updating and/or editing the action graph can include adding or removing nodes representing actions to or from the action graph, and adding or removing edges to or from the action graph.

After entry 302, the nodes of the action graph can include variables that are replaced based on the natural language input. For example, the action 304 may represent the action of navigating to web resource, where the web resource is represented by a resource variable, e.g., <locator>. The resource variable is a variable standing in for a web resource that is determined based on the natural language input. The resource variable can be displayed as a string variable. The generative model 306 may determine the web resource from analyzing the natural language input. For example, “download an image” may be interpreted by the natural language mode as an image search request. Accordingly, generative model may determine that the resource variable should be a web resource that performs an image search and cause the browser to load that web resource via action 304.

The action traversal 300 may also include an action 308 of loading or inputting a string (e.g. sequence of text), represented by <str> into a user interface element of the web resource loaded into the web browser. The generative model (e.g., the vision language model) 306 may provide the string from the natural language input. The user interface element can be identified as a search field of the image search webpage, the string being interpreted by the language model based on the natural language input. The string can include, for example, “pink elephant image” because, as part of the natural language processing of the natural language input by the AI agent, this sequence was identified as an entity and the object of the download action. The action traversal 300 can include receiving an atomic input 310 that submits the string as a query to the search engine. The atomic input 310 can be performed as a last step (part of) action 308 by the computing system simulating actions of the user, and can simulate receiving a selection or pressing of an ‘enter’ button on a keyboard. The actions of loading the string as the URL on the web browser, inputting the string into the search field of the webpage of the search engine, and submitting the string as a query (e.g., by simulating a user pressing enter), can be selected for the action traversal 300 because they correspond to a first natural language input, “Download an image of a pink elephant here.” The actions of loading the string as the URL on the web browser (action 304), inputting the string into the search field of the webpage of the search engine (action 304), and submitting the string as a query (action 312) can correspond to the node 206 shown in FIG. 2A.

After receiving the atomic input 310, the computing system, and/or a computing device in communication with the computing system, can receive the results of the search, select an image to load (action 312) and copy content from the selected image to a clipboard 314. In some implementations, the computing system searches local files (accessible and/or stored on the computing system without having to access another computing system) for a file or image that most closely matches the string or query (e.g. “pink elephant image”). The search can include providing the string or query to a search engine, such as by calling a search engine API with the string or query as a parameter included in an API call to the search engine API. In some implementations, the search engine and/or search engine API returns multiple possible files, which may be ranked in order of similarity to or likelihood of satisfying the string or query. The computing system can select the file that has a highest similarity value and/or highest likelihood of satisfying the string or query. The computing system can copy the selected file as copied content. The copied content can be an image of a pink elephant.

After copying the content to the clipboard 314, the computing system can perform an action 318 of naming the image. The computing system may name the image using a sequence of text, represented by a name variable, e.g., <name>. The sequence of text may have been provided as part of the natural language input and identified using natural language processing, such as based on an interpretation of the natural language input by the language model 316. In some implementations, the natural language processing may be performed by a language model. In some implementations (not shown), the action traversal 300 can include prompting the user for the name of the image. The action traversal 300 can include naming and saving the image locally 318. The string can be “pinkpink.png”. The naming the image as a string and saving the image locally 318 can be an action corresponding to a second natural language input, “Name it pinkpink.png”. The naming the image as a string and saving the image locally 318 can be an action corresponding to the nodes 218 and 222 shown in FIG. 2A. After naming the image as a string and saving the image locally 318, the action traversal 300 can exit 320, which corresponds to node 228 shown in FIG. 2A.

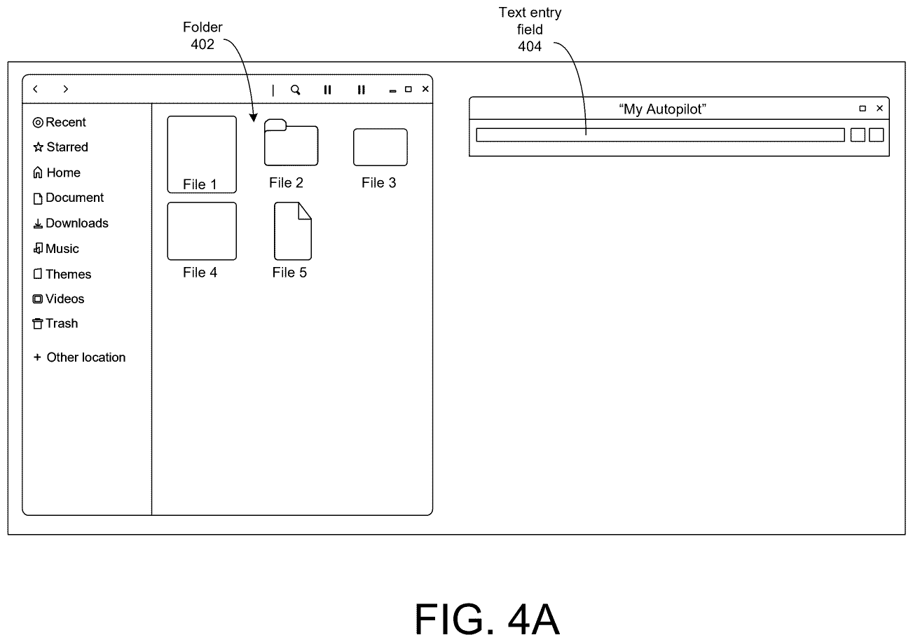

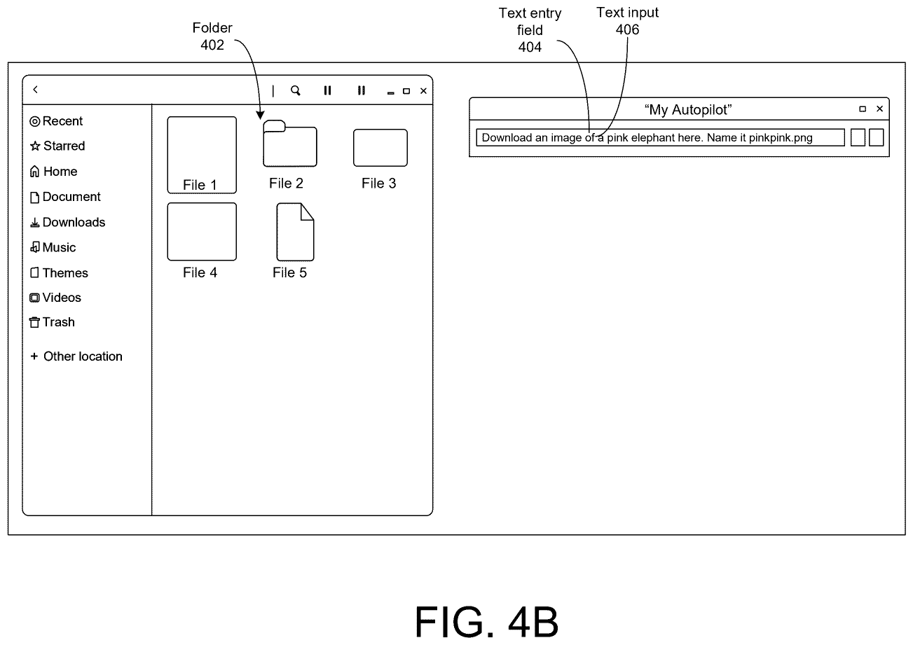

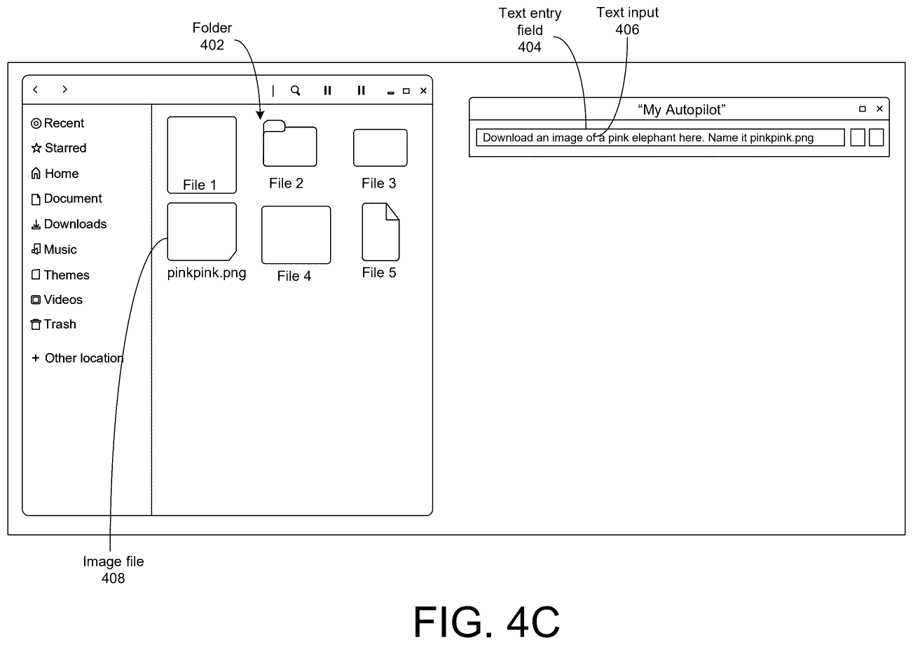

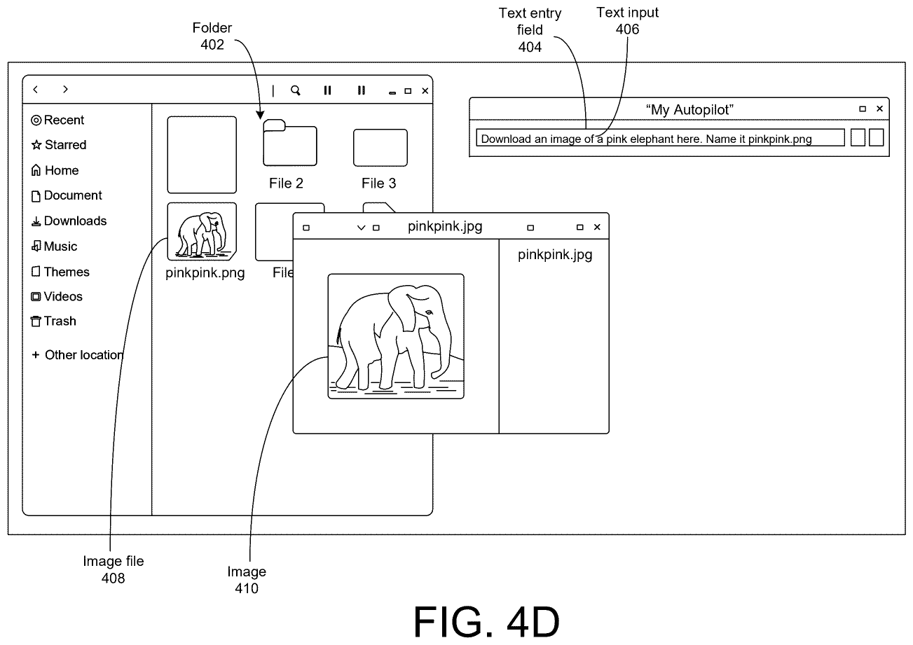

FIGS. 4A-4D show example user interfaces that may result from actions performed as part of the action traversal 300 of FIG. 3. In FIG. 4A, the user interface shows a folder 402 with files and a text entry field 404. The computing system can display the folder 402 and text entry field 404 of FIG. 4A in response to a user requesting assistance from the AI agent.

FIG. 4B shows the user interface of FIG. 4A after the text entry field 404 has received natural language input as text input 406, “Download an image of a pink elephant here. Name it pinkpink.png”. The text entry field text entry field 404 may have received the text input by the user typing into the text entry field 404 or by a transcription of audio input received from the user. FIG. 4B may result from the user providing the natural language input.

FIG. 4C shows a user interface that may be displayed as a result of the completion of action 320 of FIG. 3. The computing system has performed the action traversal of FIG. 3 and saved an image file 408, “pinkpink.png”, in the folder 402.

FIG. 4D shows an example user interface that illustrates details of the image file 408 downloaded and saved using the action traversal 300 of FIG. 3. The screenshot shows an image 410 of the pink elephant based on the image file 408, “pinkpink.png”.

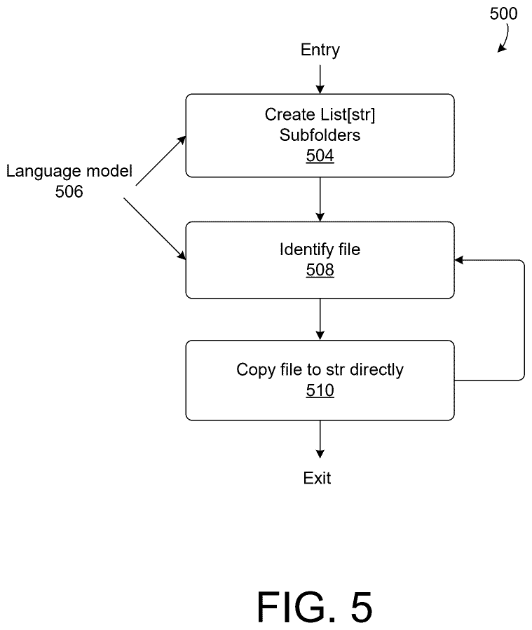

FIG. 5 shows an example action traversal 500 performed using an action graph 200 based on another natural language input. In this example, the natural language input can include text, “Organize my files into subdirectories”, which represents a requested task. In some implementations, the action traversal 500 may be presented to a user before it is processed (executed) by the AI agent. In such implementations, the user may be given an opportunity to edit the action traversal 500 before it is processed. Editing the action traversal 500 can include changing nodes, and/or a sequence of nodes, traversed during the action traversal 500. In some implementations, editing the action traversal 500 may cause the computing system to update and/or edit the action graph. Updating and/or editing the action graph can include adding or removing nodes representing actions to or from the action graph, and adding or removing edges to or from the action graph.

The computing system performs an action 504. The action 504 includes creating two or more (a list of) subfolders The computing system can determine the number of subfolders to create based on an interpretation of natural language input by a language model 506. For example, the action 504 can include performing an analysis of the files in a folder to create a recommended number of subfolders. The analysis can include clustering to determine groups of files that will be included in a same subfolder. The analysis can include classification of files into the subfolders. In addition to determining the number of subfolders, action 504 can include an action for determining the names of the subfolders. The subfolders can be created within a current folder. The names of the subfolders can be represented by strings determined by, for example, analyzing the file names and/or file content of the folder, e.g., by the language model 506. The analysis also determines which of the subfolders to copy the file to. The action traversal 500 can also include an action 510 of copying each file to the identified subfolder. The identified subfolder may be identified by a string variable. The string variable for each file may be assigned by the clustering. After the files have been copied, the method can exit. The action traversal 500 can correspond to the natural language input, “Organize my files into subdirectories”. The action 504 of creating the list of subfolders can correspond to node 216 in FIG. 2A. The actions 508 and 510 of copying the files can correspond to node 210 in FIG. 2A. Exiting can correspond to node 228 in FIG. 2A.

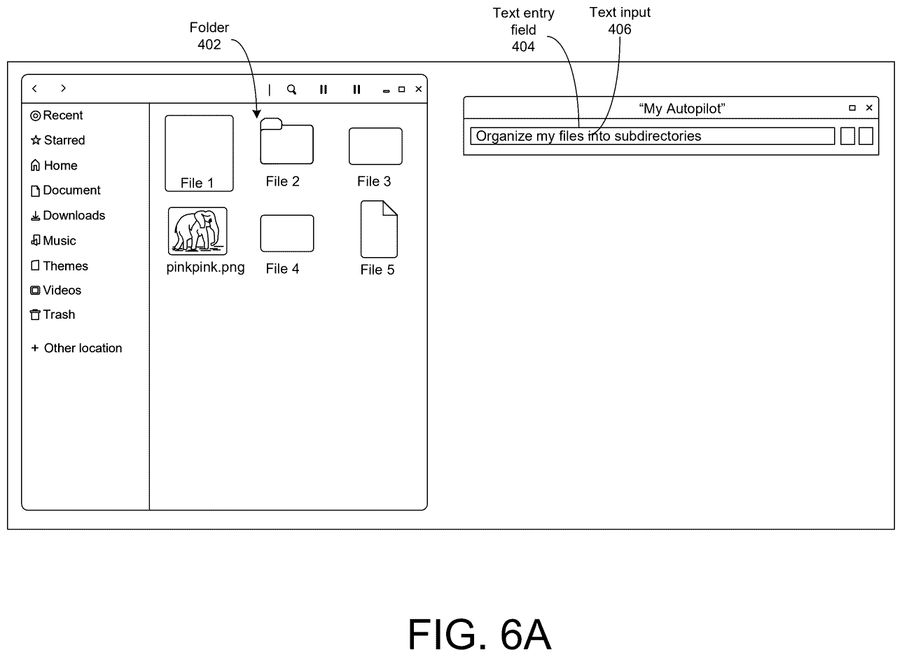

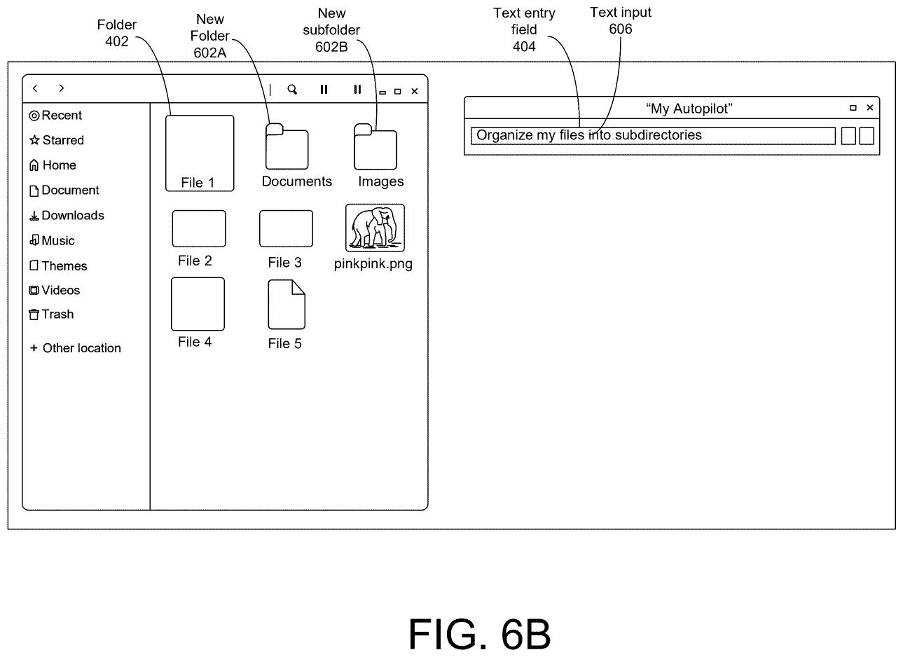

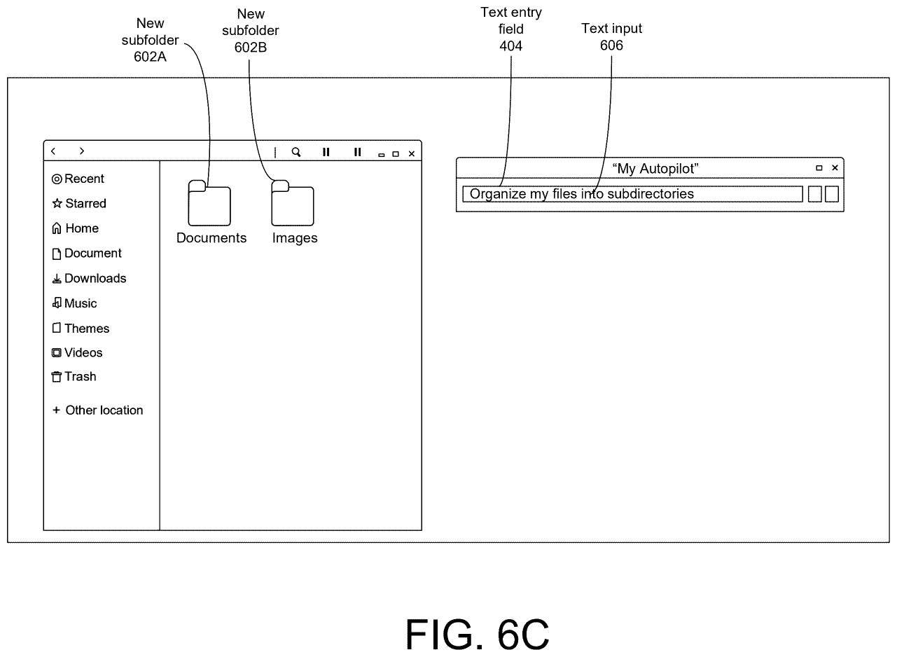

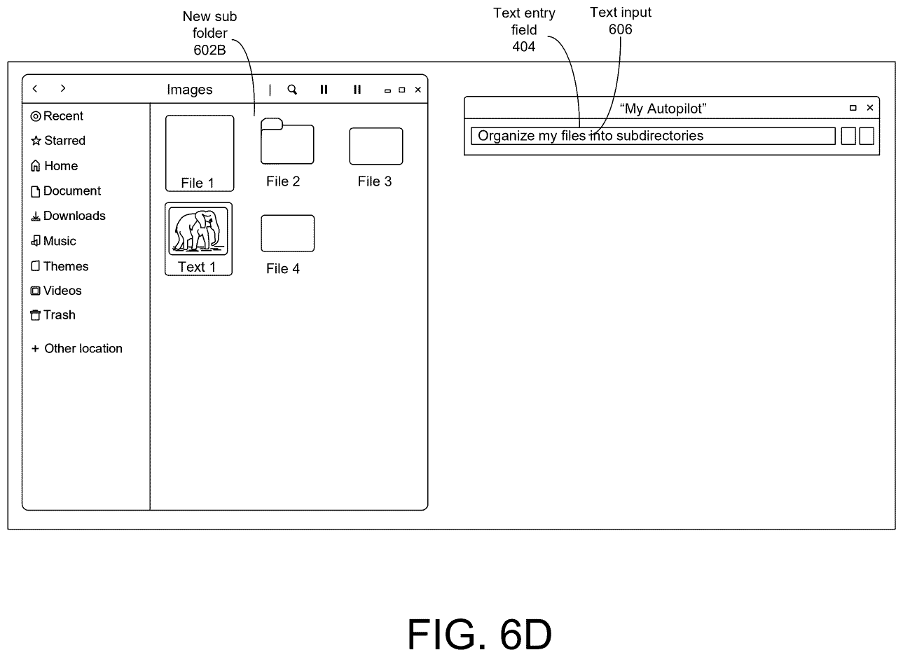

FIGS. 6A-6D show example user interfaces that may result from actions performed as part of the action traversal 500 of FIG. 5. In FIG. 6A, the text entry field 404 receives text input 606, “Organize my files into subdirectories”. The text input 606, “Organize my files into subdirectories”, can be considered natural language input. The action traversal 500 may be determined and initiated in response to receipt of the text input 606.

FIG. 6B shows a user interface generated in response to the action 504 of creating the list of subfolders of the action traversal 500 of FIG. 5. As illustrated in FIG. 6B, the computing system has created a new subfolder 602A named “Documents”, and a new subfolder 602B named “Images”.

FIG. 6C shows a user interface generated in response to actions 508 and 510 of FIG. 5. As illustrated in FIG. 6C, the text file has been saved in the new subfolder 602A and the image files have been saved in the new subfolder 602B.

FIG. 6D shows a user interface illustrating the result of the action traversal 500 of FIG. 5. In the example user interface of FIG. 6D, the user has requested the computing system to open the new subfolder 602B, which was created as part of the action traversal 500. The user may request the computing system open the new subfolder 602B such as by double clicking on the new subfolder 602B shown in FIG. 6C, and the computing system has responded by opening the new subfolder 602B. The new subfolder 602B shows the image files copied into the new subfolder 602B as a result of action 510 of action traversal 500.

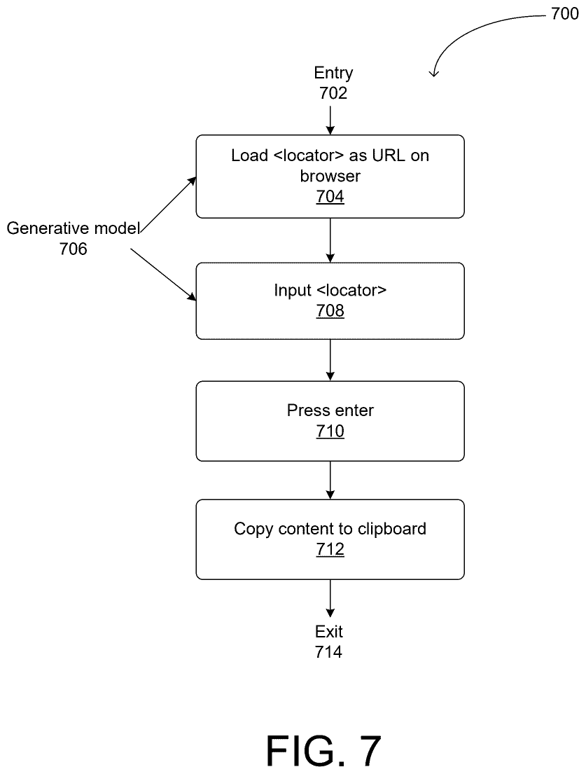

FIG. 7 shows an example action traversal 700 using an action graph, such as graph 200, based on natural language input. In this example, the natural language input can include text, “Copy info about Isaac Newton from an encyclopedia,” which represents a requested task.

After entry 702, the action traversal 700 can include the action 704, which may represent the action of navigating to web resource, where the web resource is represented by a resource variable, e.g., <locator>. The resource variable is a variable standing in for a web resource that is determined based on the natural language input. A generative model 706 may determine the web resource from analyzing the natural language input. For example, “info about Isaac Newton from an encyclopedia” may be interpreted by the natural language mode as search request. Accordingly, the generative model 706 may determine that the resource variable should be a resource locator of a search engine and cause the browser to load that web resource via action 704.

The action traversal 700 can include an action 708 of inputting a string (e.g. sequence of text) into a user interface element of the web resource, e.g., into a search field on a webpage of the search engine. The AI agent, e.g., generative model 706, may provide the string to the search field based on the natural language input. The string can include, for example, “Isaac Newton” and could include the context of “wiki” or “encyclopedia”. The action traversal 700 can include the AI agent submitting the string as a query to the search engine (e.g. by providing atomic input 710 to the search engine that simulates a user pressing enter). The action 704 of loading the string as the URL on the web browser, the action 708 of inputting the string into the search field of the webpage of the search engine, and the atomic input 710 of simulating the pressing of enter, can correspond to a first natural language input, “info about Isaac Newton from an encyclopedia.” The action 704 of loading the string as the URL on the web browser, the action 708 of inputting the string into the search field of the webpage of the search engine, and the atomic input 710 of simulating pressing enter can correspond to the node 206 shown in FIG. 2A.

After simulating pressing enter, the computing system, and/or a computing device in communication with the computing system, can copy content to a clipboard as action 712. The copied content can be information about Isaac Newton from one or more resources returned as a search result generated for the query “Isaac Newton”. Copying content to the clipboard can correspond to a second natural language input, e.g., “Copy”. The action 712 of copying content to the clipboard can correspond to node 210 and/or node 222 shown in FIG. 2A.

After copying the content to the clipboard, which can include pasting the content, the action traversal 700 can exit 714, which corresponds to node 228 shown in FIG. 2A.

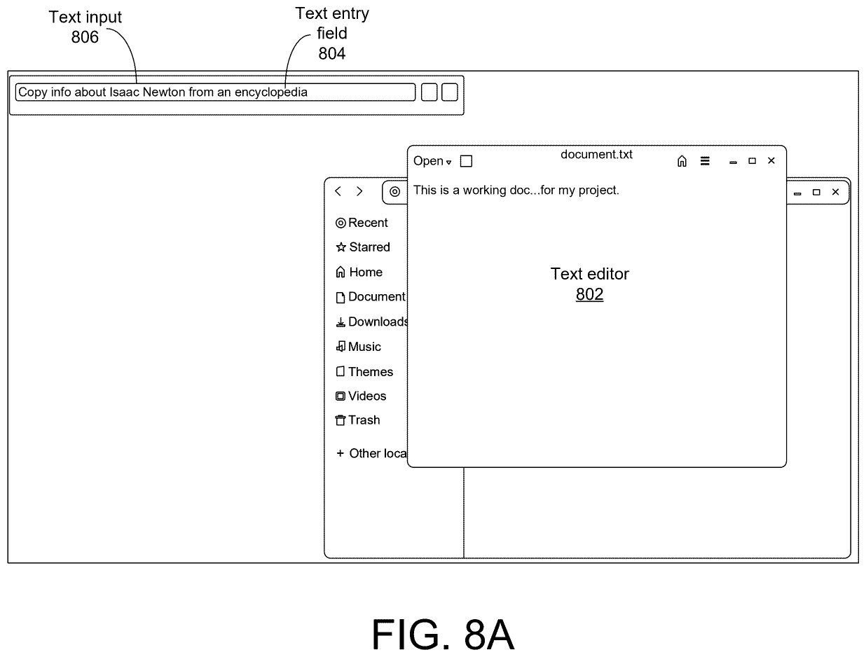

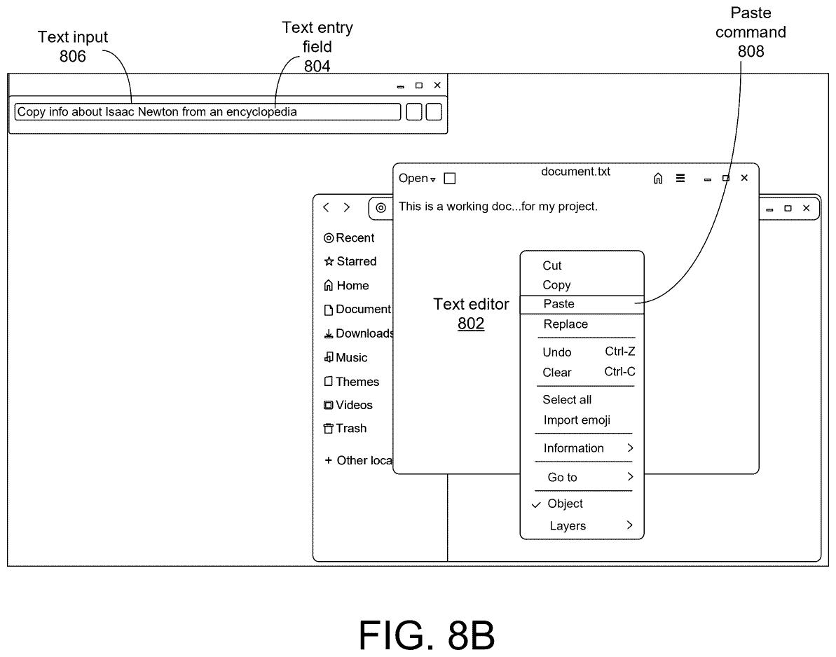

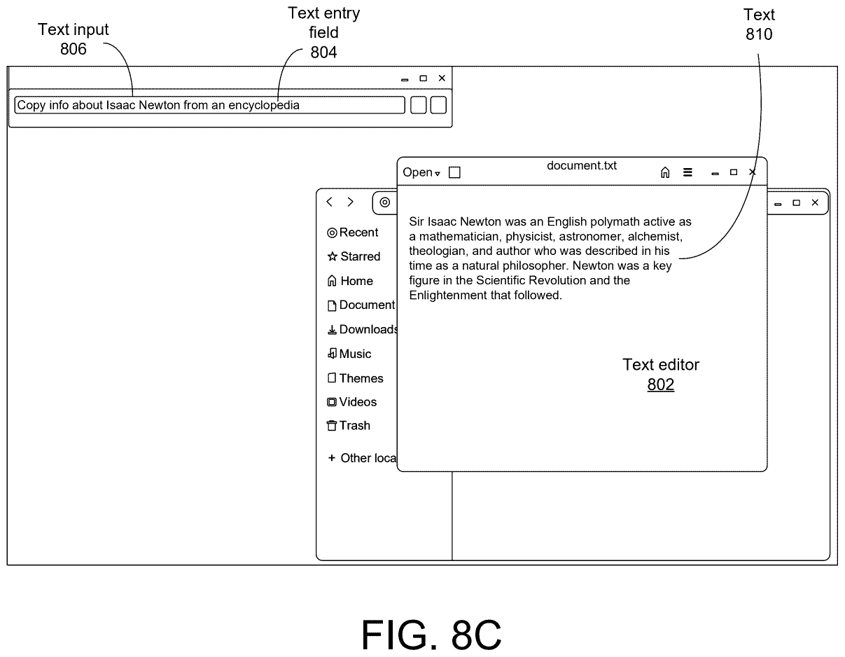

FIGS. 8A-8C show example user interfaces that may result from actions performed as part of the action traversal 700 of FIG. 7. The text entry field 804 may be displayed in response to a user requesting assistance from the AI agent. FIG. 8A shows a text editor 802 into which text can be typed, and/or copied text. The text editor 802 represents a location into which text can be entered or pasted. In the example of FIG. 8A, the user has entered text input 806 of “Copy info about Isaac Newton from an encyclopedia” into the text entry field 804. The text input 806 is natural language input representing a requested task for the AI agent to perform.

FIG. 8B shows the text editor 802 after the action traversal of FIG. 7 has been performed and the AI agent has responded to the text input 806 entered into the text entry field 804 as shown in FIG. 8A. The information about Isaac Newton has been copied to the clipboard, and the computing system is presenting a paste command 808 for the user to paste the information about Isaac Newton into the text editor 802.

FIG. 8C shows the text editor 802 after the paste command 808 shown in FIG. 8B has been selected. The user has instructed the computing system to paste the information that was copied to the clipboard into the text editor 802, and the computing system has responded to the instruction by pasting the information about Isaac Newton, in the form of text 810, into the text editor 802.

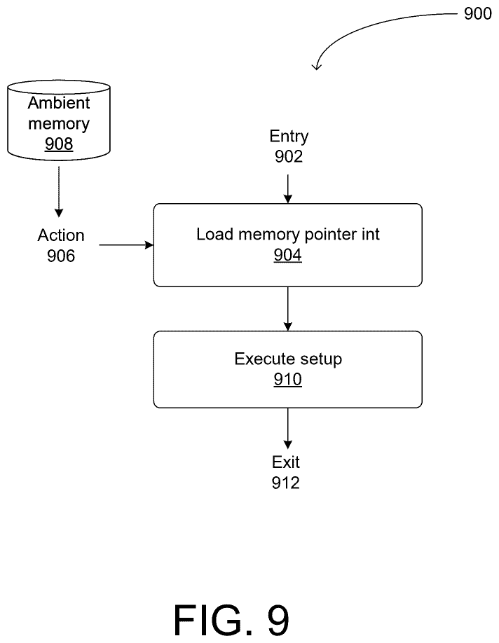

FIG. 9 shows an example action traversal 900 using an action graph, such as graph 200, based on natural language input. In this example, the natural language input can include text, “Open up my work setup from yesterday.” Based on the analysis of input, e.g., by a language model 906, actions 904 and 910 may be selected for the action traversal. After entry 902, action 904 of the action traversal 900 includes loading a memory pointer, which can be an integer value. The memory pointer can be stored in an ambient memory 908. The ambient memory 908 can be main memory such as random access memory or a long-term memory such as a hard drive. The memory pointer can indicate a location in memory where a work setup of the user is stored. The work setup can include applications that the user opens and/or interacts with during work periods. After loading the memory pointer, the action traversal 900 includes action 910, which executes the setup. Executing the setup can include opening the applications that the user opens and/or interacts with during work. After executing the setup (e.g., action 910), the action traversal 900 can exit 912.

FIGS. 10A and 10B show example user interfaces that may result from actions performed as part of the action traversal 900 of FIG. 9. In the example of FIG. 10A, the text entry field 1004 may be displayed in response to a request from the user to use the AI agent. In the example of FIG. 10A, the user has entered, into a text entry field 1004, text input 1006, “Open up my work setup from yesterday.” The text input 1006 is the natural language input representing a task requested by the user for the AI agent to perform.

FIG. 10B shows a user interface after the method of FIG. 9 has been performed and the AI agent has responded to the text input 1006 by opening applications 1010. The computing system has opened applications 1010 that the user opens and/or interacts with during work periods.

FIG. 11 is a block diagram of a computing system 1100. The computing system 1100 can perform any combination of the methods, functions, and/or techniques described herein. The computing system 1100 can represent a single computing device, or multiple computing devices that perform the methods, functions, and/or techniques described herein in a distributed system.

The computing system 1100 can include an AI agent 1101 configured to generate and use an action graph to perform tasks requested by a user. The AI agent 1101 can include and/or have access to a generative model 1102, which can include or be a language model, vision model, or multimodal model, as non-limiting examples. The generative model 1102 can interpret natural language input to determine a goal or task of the natural language input, generate a graph (such as an action graph) based on an action repository, which may be based on applications and/or features available on the computing system 1100, and/or determine nodes of the action graph to traverse based on the natural language input and history of selections of actions represented by nodes of the graph. Put another way, one or more of a language input processor included in the AI agent 1101, the graph generator 1104 and/or the graph traverser 1112 may be implemented by the generative model 1102.

The computing system 1100, AI agent 1101, and/or graph generator 1104 can implement language processing. The language processing can include processing natural language input received by the computing system 1100. The natural language input can include text typed by a user or a transcription of audio input spoken by the user. The language processing can implement natural language understanding to recognize intent to identify a user's sentiment in input text and determine an objective of the input text. In some implementations, the language processing can include identifying an entity in the input text and extracting information about the entity. In some implementations, the language processing can include parsing text input into portions (such as a first natural language input and a second natural language input) based on divisions of actions and objects. In some implementations, the language processing can include parsing text input into portions based on the portions being transcribed from audio inputs that are separated by at least a pause duration threshold. The pause duration threshold can indicate that the user was expressing different intentions. In some implementations, the language processing is implemented by the generative model 1102.

The computing system 1100 and/or AI agent 1101 can include a graph generator 1104. The generative model 1102 can call the graph generator 1104 based on language input processed by the generative model 1102. The graph generator 1104 can generate a graph of possible functions and/or actions used to perform a task requested in natural language input. Examples of graphs that the graph generator 1104 can generate are the graph 104 shown in FIG. 1, the graph 200 shown in FIG. 2A, and the graph 250 shown in FIG. 2B.

In some implementations, the graphs 200, 250 shown in FIGS. 2A and 2B can be considered action repositories. The action repositories indicate possible actions that can be performed by the computing device and the order in which those actions can be performed, i.e., which action nodes follow an action represented by a given node. For example, searching the web (represented by node 206) can occur after opening the web browser (represented by node 204), but opening the web browser (represented by node 204) cannot occur after searching the web (represented by node 206) has already occurred.

The graph generator 1104 can generate an action repository. The graph generator 1104 can generate the action repository based on a user interface, and/or multiple user interfaces, presented to a user and applications available to the user. The action repository can include nodes that represent actions, and edges between nodes representing sequence of actions, that the user could take by providing input to the computing system 1100. The edges connect nodes representing actions that could take place before or after actions represented by nodes to which the nodes are connected. For example, a file or folder can be closed only after the file or folder has been opened, so a node representing closing a file or folder appears later in a hierarchy of nodes than a node representing opening the file or folder.

The graph generator 1104 can prune edges within an action repository, such as either of the graphs 200, 250 shown in FIGS. 2A and 2B, to generate an action graph, such as the graph 104 shown in FIG. 1. The graph generator 1104 can prune the edges from the action repository to generate the action graph based on likelihoods of traversing the edges. In some implementations, the likelihoods of traversing the edges are based on previous actions by the user or other users who have explicitly granted permission to collect data about actions performed within a computing device. In some implementations, the likelihoods of traversing the edges are based on a combination of records of previous actions by the user or other users and the natural language input. The natural language input can indicate sequences of likely actions to perform a task. The graph generator 1104 can prune edges for which a likelihood of traversal, based on the previous actions and/or natural language input, does not satisfy a probability threshold. The graph generator 1104 can generate the action graph by pruning edges from the action repository. If no edge leads to a particular node in the action repository after the graph generator 1104 has pruned the edges, then the graph generator 1104 can remove the particular node. The removal of edges and/or nodes by the graph generator 1104 results in an action graph such as the graph 104. In some implementations, the nodes in the action graph each represent an action that has at least a threshold probability of occurring if an action represented by a preceding node (to which the node is connected) occurs. The action graph has fewer nodes than the action repository, enabling traversal of the action graph with fewer computational resources than would be required to traverse the action repository.

The graph generator 1104 can include an input surveyor 1106. The input surveyor 1106 can survey inputs of a user of an application and/or inputs of other users of instances of the application. The input surveyor 1106 can determine, for example, how frequently users perform actions such as selecting certain functions, APIs, hyperlinks, text entries, scrolls along scrollbars, or button clicks as non-limiting examples. The input surveyor 1106 can compile data to determine frequencies or likelihoods of selections.

The input surveyor 1106 can, with user permission, monitor, record, and/or store actions performed and/or selected by a user. The actions can be represented as nodes in the action repository, which can add and/or re-weight edges based on how users actually performed actions for a given task. The edges can represent selections of actions after selection of a given action and the weight of an edge can represent the frequency of a particular action after a given source action, or in other words, the likelihood of selecting possible actions after selection and/or performance of the given action.

The graph generator 1104 can include a node generator 1108. The node generator 1108 can generate nodes that represent possible actions within a function, such as selecting certain functions, APIs, hyperlinks, text entries, scrolls along scrollbars, or button clicks as non-limiting examples. In some implementations, the graph generator 1104 updates the graph by the node generator 1108 adding nodes associated with actions that can be performed after actions that have already been selected and/or performed. In some implementations, the node generator 1108 excludes nodes based on determinations that actions corresponding to the excluded nodes are not performed or selected frequently enough for the corresponding node to be included in the graph.

The graph generator 1104 can include an edge processor 1110. The edge processor 1110 can determine whether to create, or prune, edges between nodes within the graph. The presence of edges between nodes can allow actions represented by nodes to be performed if the nodes are connected by edges. The edge processor 1110 can determine whether to create or prune edges based on histories of performing actions represented by nodes connected by the edges (as determined by the input surveyor 1106) and/or based on the goal of the natural language input (as determined by the generative model 1102).

The edge processor 1110 can compare the frequencies determined by the input surveyor 1106 to one or more frequency thresholds. The edge processor 1110 can determine whether the frequencies or likelihoods of selections satisfy the frequency threshold based on whether the frequency or likelihood determined by the input surveyor 1106 meets or exceeds the frequency threshold. The edge processor 1110 can determine that the frequency of selections satisfies the frequency threshold if the frequency determined by the input surveyor 1106 meets or exceeds the frequency threshold. The edge processor 1110 can determine that the frequency of selections does not satisfy the frequency threshold if the frequency determined by the input surveyor 1106 does not meet or exceed the frequency threshold.

The edge processor 1110 can create an edge, or allow an edge to remain rather than pruning the edge, between nodes if the edge processor 1110 determines that the frequency of the action to which the node corresponds satisfies the frequency threshold. The edge processor 1110 can determine not to create an edge, or prune an edge, between nodes if the edge processor 1110 determines that the frequency of the action to which the node corresponds does not satisfy the frequency threshold.

The AI agent 1101 can include a graph traverser 1112. The generative model 1102 can call the graph traverser 1112 based on language input processed by the generative model 1102. The graph traverser 1112 can determine nodes, representing actions, to traverse within the action graph. Traversing a node can cause an action processor 1114 to process and/or perform an action associated with the traversed node. The graph traverser 1112 can determine the nodes to traverse within the action graph based on the task or goal determined by the generative model 1102. The graph traverser 1112 can determine the nodes to traverse that are most likely to achieve the goal determined by the generative model 1102. The graph traverser 1112 can determine likelihoods of nodes achieving the goal based on comparison of the goal to the actions. In some implementations, the graph traverser 1112 can determine the nodes to achieve the goal based on assistance of a language model. The graph traverser 1112 can, for example, prompt the language model to indicate which nodes to traverse with a prompt that includes the goal and the nodes representing actions within the action graph.

The computing system 1100 can include an action processor 1114. The action processor 1114 can process and/or perform the actions and/or functions to which the nodes correspond based on the natural language input. The action processor 1114 can, for example, implement functions, launch applications, call APIs, enter text input into fields select buttons or hyperlinks, or scroll on scrollbars, as non-limiting examples.

The computing system 1100 can include at least one processor 1116. The at least one processor 1116 can execute instructions, such as instructions stored in at least one memory device 1118, to cause the computing system 1100 to perform any combination of methods, functions, and/or techniques described herein.

The computing system 1100 can include at least one memory device 1118. The at least one memory device 1118 can include a non-transitory computer-readable storage medium. The at least one memory device 1118 can store data and instructions thereon that, when executed by at least one processor, such as the processor 1116, are configured to cause the computing system 1100 to perform any combination of methods, functions, and/or techniques described herein. Accordingly, in any of the implementations described herein (even if not explicitly noted in connection with a particular implementation), software (e.g., processing modules, stored instructions) and/or hardware (e.g., processor, memory devices, etc.) associated with, or included in, the computing system 1100 can be configured to perform, alone, or in combination with the computing system 1100, any combination of methods, functions, and/or techniques described herein.

The computing system 1100 may include at least one input/output node 1120. The at least one input/output node 1120 may receive and/or send data, such as from and/or to, a server, and/or may receive input and provide output from and to a user. The input and output functions may be combined into a single node, or may be divided into separate input and output nodes. The input/output node 1120 can include, for example, a display that presents output such as textual output, a camera, a speaker, a microphone, one or more buttons, a keyboard, and/or one or more wired or wireless interfaces for communicating with other computing devices.

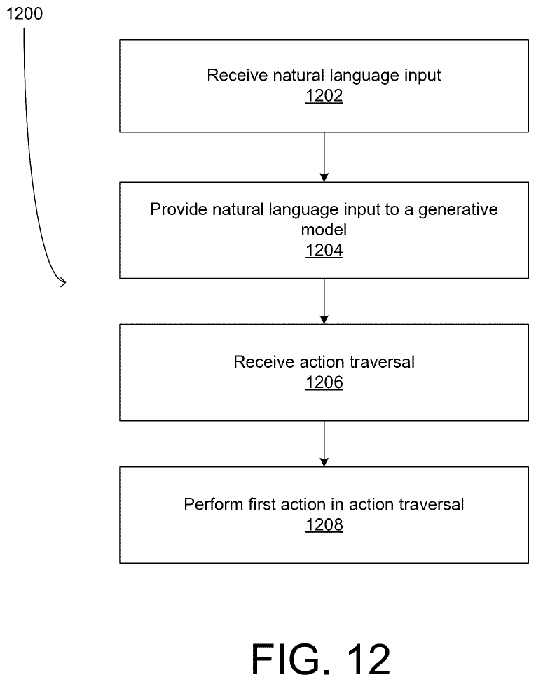

FIG. 12 is a flowchart of a method 1200 performed by a computing system. The method 1200 can be performed by the computing system 1100, another computing device, or distributed between multiple computing devices.

The method 1200 includes receiving natural language input (1202). Receiving natural language input (1202) can include receiving a natural language input related to a task. The method 1200 includes providing natural language input to a generative model (1204). The generative model can identify an action traversal for performing the task based on the natural language input. The action traversal can represent a path through an action graph. The action graph can include a plurality of nodes representing actions relevant to the task. The nodes can be connected by edges representing probabilities of child nodes following parent nodes. The method 1200 includes receiving an action traversal (1206). The method 1200 can include performing a first action in the action traversal (1208). Performing the first action in the action traversal can include, in response to receiving the action traversal, performing the first action in the action traversal.

In some examples, the method 1200 further includes generating the action graph by pruning edges from an action repository based on probabilities of traversing the edges between nodes connected by the edges, the action repository including nodes connected by edges where connected nodes represent possible actions after previous actions have occurred.

In some examples, the probabilities of traversing the edges are based on a user intent and a reliability score.

In some examples, the user intent is determined from the natural language input.

In some examples, performing the first action includes determining that a correlation between a second natural language input and the first action is higher than a correlation between the second natural language input and a second action.

In some examples, the method 1200 further includes presenting the action traversal to a user, receiving an edit to the action traversal, and performing the task according to the edited action traversal.

In some examples, the method 1200 further includes editing the action graph based on the edit to the action traversal.

In some examples, performing the first action includes providing input to an application associated with the task, the input being based on the natural language input.

In some examples, the first action includes multiple subtasks.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

Clause 1. A method comprising: receiving a first natural language input related to a task; providing the first natural language input to a generative model, the generative model identifying an action traversal for performing the task, the action traversal representing a path through an action graph, the action graph including a plurality of nodes representing actions, the nodes connected by edges representing probabilities of second nodes following first nodes; receiving the action traversal; and in response to receiving the action traversal, performing a first action in the action traversal.

Clause 2. The method of clause 1, further comprising: presenting the action traversal to a user; receiving an edit to the action traversal; and performing the task according to the edited action traversal.

Clause 3. The method of clause 1, wherein performing the first action includes determining that a correlation between a second natural language input and the first action is higher than a correlation between the second natural language input and a second action.

Clause 4. The method of clause 1, wherein the task is indicated by the first natural language input.

Clause 5. The method of clause 1, wherein generating the action graph includes: including the first node in the action graph based on a determination that a frequency of previous selections of the first action satisfies a frequency threshold; including a second node in the action graph based on a determination that a frequency of previous selections of the second action satisfies the frequency threshold; and determining not to include a node corresponding to an unincluded action in the graph based on a determination that a frequency of previous selections of the unincluded action does not satisfy the frequency threshold.

Clause 6. The method of clause 1, wherein generating the action graph includes removing, from the action graph, a third node being associated with the task and corresponding to a third action within the task based on a determination that a frequency of previous selections of the third action does not satisfy a frequency threshold.

Clause 7. The method of clause 1, wherein performing the first action includes providing input to an application associated with the first action, the input being based on a second natural language input.

Clause 8. The method of clause 1, wherein performing the first action includes providing text input to an application associated with the first action, the text input being based on a second natural language input.

Clause 9. The method of clause 8, wherein the first natural language input and the second natural language input are included in a single sentence.

Clause 10. The method of clause 8, wherein the first natural language input is based on a first audio input and the second natural language input is based on a second audio input, the first audio input and the second audio input being separated by at least a pause duration threshold.

Clause 11. The method of clause 1, wherein performing the first action includes launching an application.

Clause 12. The method of clause 1, wherein performing the first action includes calling an application programming interface.

What is claimed is:

1. A method comprising:
receiving a natural language input related to a task;
providing the natural language input to a generative model, the generative model identifying an action traversal for performing the task based on the natural language input, the action traversal representing a path through an action graph, the action graph including a plurality of nodes representing actions relevant to the task, the nodes connected by edges representing probabilities of child nodes following parent nodes;
receiving the action traversal; and
in response to receiving the action traversal, performing a first action in the action traversal.

2. The method of claim 1, further comprising generating the action graph by pruning edges from an action repository based on probabilities of traversing the edges between nodes connected by the edges, the action repository including nodes connected by edges where connected nodes represent possible actions after previous actions have occurred.

3. The method of claim 2, wherein the probabilities of traversing the edges are based on a user intent and a reliability score.

4. The method of claim 3, wherein the user intent is determined from the natural language input.

5. The method of claim 1, wherein performing the first action includes determining that a correlation between a second natural language input and the first action is higher than a correlation between the second natural language input and a second action.

6. The method of claim 1, further comprising:
presenting the action traversal to a user;
receiving an edit to the action traversal; and
performing the task according to the edited action traversal.

7. The method of claim 6, further comprising editing the action graph based on the edit to the action traversal.

8. The method of claim 1, wherein performing the first action includes providing input to an application associated with the task, the input being based on the natural language input.

9. The method of claim 1, wherein the first action includes multiple subtasks.

10. A non-transitory computer-readable storage medium comprising instructions stored thereon that, when executed by at least one processor, are configured to cause a computing system to:
receive a natural language input related to a task;
provide the natural language input to a generative model, the generative model identifying an action traversal for performing the task based on the natural language input, the action traversal representing a path through an action graph, the action graph including a plurality of nodes representing actions relevant to the task, the nodes connected by edges representing probabilities of child nodes following parent nodes;
receive the action traversal; and
in response to receiving the action traversal, perform a first action in the action traversal.

11. The non-transitory computer-readable storage medium of claim 10, wherein the instructions are further configured to cause the computing system to generate the action graph by pruning edges from an action repository based on probabilities of traversing the edges between nodes connected by the edges, the action repository including nodes connected by edges where connected nodes represent possible actions after previous actions have occurred.

12. The non-transitory computer-readable storage medium of claim 10, wherein performing the first action includes determining that a correlation between a second natural language input and the first action is higher than a correlation between the second natural language input and a second action.

13. The non-transitory computer-readable storage medium of claim 10, wherein the instructions are further configured to cause the computing system to:
present the action traversal to a user;
receive an edit to the action traversal; and
perform the task according to the edited action traversal.

14. The non-transitory computer-readable storage medium of claim 10, wherein performing the first action includes providing input to an application associated with the task, the input being based on the natural language input.

15. The non-transitory computer-readable storage medium of claim 10, wherein the first action includes multiple subtasks.

16. A computing system comprising:
at least one processor; and
a non-transitory computer-readable storage medium comprising instructions stored thereon that, when executed by the at least one processor, are configured to cause the computing system to:
receive a natural language input related to a task;
provide the natural language input to a generative model, the generative model identifying an action traversal for performing the task based on the natural language input, the action traversal representing a path through an action graph, the action graph including a plurality of nodes representing actions relevant to the task, the nodes connected by edges representing probabilities of child nodes following parent nodes;
receive the action traversal; and
in response to receiving the action traversal, perform a first action in the action traversal.

17. The computing system of claim 16, wherein the instructions are further configured to cause the computing system to generate the action graph by pruning edges from an action repository based on probabilities of traversing the edges between nodes connected by the edges, the action repository including nodes connected by edges where connected nodes represent possible actions after previous actions have occurred.

18. The computing system of claim 16, wherein performing the first action includes determining that a correlation between a second natural language input and the first action is higher than a correlation between the second natural language input and a second action.

19. The computing system of claim 16, wherein the instructions are further configured to cause the computing system to:
present the action traversal to a user;
receive an edit to the action traversal; and
perform the task according to the edited action traversal.

20. The computing system of claim 16, wherein performing the first action includes providing input to an application associated with the task, the input being based on the natural language input.
